(19) United States
(12) Patent Application Publication
(10) Pub. No.: US 2022/0143949 A1
(43) Pub. Date: May 12, 2022

(54) LAMINATION FILM AND LIGHT-TRANSMITTING LAMINATE INCLUDING SAME

(71) Applicant: SKC Co., Ltd., Suwon-si (KR)

(72) Inventors: Hyejin KIM, Suwon-si (KR); Sungjin CHUNG, Seoul (KR); Kyuhun KIM, Seoul (KR)

(73) Assignee: SKC Co., Ltd., Suwon-si (KR)

(21) Appl. No.: 17/580,114

(22) Filed: Jan. 20, 2022

Related U.S. Application Data
(63) Continuation of application No. PCT/KR2020/018868, filed on Dec. 22, 2020.

(30) Foreign Application Priority Data
Dec. 31, 2019 (KR) 10-2019-0179330

(51) Int. Cl. B32B 3/26; B32B 17/06; B32B 27/30

(52) U.S. Cl. CPC B32B 3/263; B32B 17/06; B32B 2307/406; B32B 2605/00; B32B 2307/412; B32B 27/306

(57) ABSTRACT

The lamination film includes an increasing thickness area, wherein a thickness of the increasing thickness area increases from a first end to a second end, wherein the lamination film comprises at least one surface comprising a plurality of embossments, and wherein at least a portion of the at least one surface is disposed on a surface of the increasing thickness area.

### CROSS-REFERENCE TO RELATED APPLICATION

Pursuant to 35 USC 120 and 365(c), this application is a continuation of International Application No. PCT/KR2020/018868 filed on Dec. 22, 2020, and claims the benefit under 35 USC 119(a) of Korean Application No. 10-2019-0179330 filed on Dec. 31, 2019, in the Korean Intellectual Property Office, the entire disclosures of which are incorporated herein by reference for all purposes.

### BACKGROUND

Polyvinyl acetal is being used as an interlayer (film for laminated glass) of a laminated glass (safety glass) or a light-transmitting laminate. Laminated glass is mainly used in windows of architecture, cladding, and window glass of automobiles, and due to characteristics such as anti-scattering of glass fragments when broken and penetration resistance against impact of a certain strength, it can secure stability for minimizing damage or injury given to objects or people located inside thereof.

A lamination film has plural minute embossments formed at the surface to prevent blocking among interlayers, to improve handling workability during overlapping a glass plate with an interlayer (degree of smooth sliding between an interlayer and a glass plate), and to improve de-airing performance when processed to be laminated with a glass plate.

When a lamination film, in which embossments are formed, is used in lamination, there is a possibility of generating an interference pattern or a bubble due to the embossments disposed on both surfaces of the film, and a visibility may be decreased. Also, there is a problem of workability when a dazzle occurs on the surface of a lamination film.

### SUMMARY

In one general aspect, the lamination film includes an increasing thickness area, wherein a thickness of the increasing thickness area increases from a first end to a second end, wherein the lamination film includes at least one surface comprising a plurality of embossments, and wherein at least a portion of the at least one surface is disposed on a surface of the increasing thickness area.

A maximum value among gloss values measured at an acceptance angle of 20°, 45°, 60°, 75° and 85° may be 15% or less at a first portion and a second portion separated from the first portion on the at least one surface, respectively.

A Spd value (number of peaks per unit area) of the at least one surface may be 200 mm⁻² or more.

When a thickness of the first end is referred to as Ha and a distance from the first end to the second end is referred to as w, a ratio of the Ha to the w may be 0.0002 to 0.0015.

A standard deviation of gloss values measured at an acceptance angle of 20°, 45°, 60°, 75° and 85° may be 6% or less at a first portion and a second portion separated from the first portion on the at least one surface, respectively.

A difference between the maximum value and a minimum value among gloss values measured at an acceptance angle of 20°, 45°, 60°, 75° and 85° may be 10% or less at the first portion.

The Spd value of the at least one surface may be 1500 mm⁻² or less.

A Sku value (kurtosis value) of the at least one surface may be 0.5 to 4.

A S10z value (ten point height of irregularities) of the at least one surface may be 30 to 90 μm.

The at least one surface may include minute unevenness.

The lamination film may be a monolayer film with one layer or a multilayer film with two layers or more.

The lamination film may include a polyvinyl acetal resin.

In another general aspect, the light-transmitting laminate includes: a first light-transmitting layer; a lamination film disposed on one surface of the first light-transmitting layer; and a second light-transmitting layer disposed on the lamination film, wherein the lamination film comprises an increasing thickness area, wherein a thickness of the increasing thickness area increases from a first end to a second end, wherein the lamination film includes at least one surface comprising a plurality of embossments, and wherein at least a portion of the at least one surface is disposed on a surface of the increasing thickness area.

A maximum value among gloss values measured at an acceptance angle of 20°, 45°, 60°, 75° and 85° may be 15% or less at a first portion and a second portion separated from the first portion on the at least one surface, respectively.

A Spd value (number of peaks per unit area) of the at least one surface may be 200 mm⁻² or more.

When a thickness of the first end is referred to as Ha and a distance from the first end to the second end is referred to as w, a ratio of the Ha to the w may be 0.0002 to 0.0015.

A standard deviation of gloss values measured at an acceptance angle of 20°, 45°, 60°, 75° and 85° may be 6% or less at a first portion and a second portion separated from the first portion on the at least one surface, respectively.

A difference between the maximum value and a minimum value among gloss values measured at an acceptance angle of 20°, 45°, 60°, 75° and 85° may be 10% or less at the first portion.

The Spd value of the at least one surface may be 1500 mm⁻² or less.

A Sku value (kurtosis value) of the at least one surface may be 0.5 to 4.

Other features and aspects will be apparent from the following detailed description and the claims.

### BRIEF DESCRIPTION OF THE DRAWINGS

FIG. 1 and FIG. 2 are sectional views of schematically showing the lamination film according to one embodiment, respectively.

FIGS. 3A and 3B are sectional views of showing a gloss measuring part of the lamination film according to different embodiments, respectively.

FIGS. 4A, 4B and 4C are sectional views of schematically showing the lamination films including a sound insulating layer according to different embodiments, respectively.

FIG. 5 is a conceptual view of illustrating an embossment roller applied to the manufacturing process of the lamination film of Comparative Example.

FIG. 6 is a conceptual view of illustrating the process of forming surface embossments in the manufacturing process of the lamination film manufactured in one example of the embodiments.

Throughout the drawings and the detailed description, the same reference numerals refer to the same elements. The drawings may not be to scale, and the relative size, proportions, and depiction of elements in the drawings may be exaggerated for clarity, illustration, and convenience

### DETAILED DESCRIPTION

Hereinafter, example embodiments will be described in detail so that they can be easily practiced by those skilled in the art to which the embodiment pertains. However, the example embodiments may be embodied in many different forms and is not to be construed as being limited to the embodiments set forth herein.

In this specification, the term for degree like “about”, “substantially” and the like is used for meaning values approximative from/to the value when a tolerance to be proper to referred meaning for manufacture and substance is presented. Additionally, these terms for degree are used to help understanding of example embodiments and to prevent that an unconscionable trespasser unjustly uses the presented content in which exact or absolute number is referred.

Throughout this specification, the phrase “combination(s) thereof” included in a Markush-type expression denotes one or more mixtures or combinations selected from the group consisting of components stated in the Markush-type expression, that is, denotes one or more components selected from the group consisting of the components are included.

Throughout this specification, the description of “A and/or B” means “A, B, or A and B.”

Throughout this specification, terms such as “first”, “second”, “A”, or “B” are used to distinguish the same terms from each other unless specially stated otherwise.

In this specification, “B being placed on A” means that B is placed in direct contact with A or placed over A with another layer or structure interposed therebetween and thus should not be interpreted as being limited to B being placed in direct contact with A.

In this specification, a singular form is contextually interpreted as including a plural form as well as a singular form unless specially stated otherwise.

In this specification, embossments are unevenness present on a surface of a lamination film, and mean wavelength, from which the minute unevenness components, which are small scale lateral components, have been removed by using an S-filter which is defined in ISO 25178-2:2012DML PART2, after measuring a sectional curve of a lamination film. A convex portion of embossments is referred to as a peak, and a concave portion of embossments is referred to as a valley.

In this specification, the amount of a hydroxyl group was evaluated by measuring an amount of ethylene group combined with the hydroxyl group of the polyvinyl acetal resin by a method in accordance with JIS K6728.

Spd (number of peaks per unit area), Sku (kurtosis), S10z (ten point height of irregularities) values are values evaluated according to ISO_25178, and measurable by using a 3D roughness meter.

The Spd value is a value evaluated according to ISO_25178. The Spd value means the number of peaks per unit area.

The Sku value is a value evaluated according to ISO_25178. The Sku value is an index for evaluating kurtosis in a certain area.

The S10z value is a value evaluated according to ISO_25178. The S10z value means the sum of an average value of five heights of the highest peaks and an average value of five depths of the lowest valleys. That is, the S10z is evaluated by below Equation 1:

$$S 10 z = S 5 p + S 5 v . \qquad [ Equation 1 ]$$

A lamination film may be laminated with a light-transmitting body to form a light-transmitting laminate. An image may be projected to the light-transmitting laminate and thereby Head Up Display can be provided to a user (driver). However, the image projected to the light-transmitting laminate may form a double image during transmitting or reflecting the light-transmitting material such as glass and the lamination film, respectively, and this may be recognized as a ghost image to a user or may degrade definition of the image. To prevent such a phenomenon, a lamination film having a wedge shape is applied for Head Up Display.

Meanwhile, the lamination film may obtain a surface embossment characteristic such as a regular unevenness pattern or a melt fracture, in order to prevent unnecessary adhesion between surfaces when winded and to achieve de-airing performance when laminated with a light-transmitting laminate such as a glass plate.

The lamination film having surface embossment characteristics through a transcribing process, or the like may be winded to be a roll form. Before interposing the lamination film between two pieces of laminated glass for lamination thereof, a worker unwinds the film in a roll form and simultaneously performs work for inspecting the appearance of the film, such as check for presence of foreign matters.

In the process for inspecting the appearance of the film, an illuminated light around workplace may be reflected on the surface of the film in a roll form and may affect the inspection. Particularly, when a wedge-shaped lamination film is winded to be a roll form, a portion with a thin thickness in the lamination film may generate a wrinkle on the surface thereof during the formation of a roll. When the illuminated light is reflected to the wrinkled surface, irregular surface gloss may be formed in the corresponding surface and visibility may be degraded when the appearance of a film is inspected.

Upon confirming visibility of a lamination film can be improved by controlling the form of a lamination film to prevent a Head Up Display image from forming a double image, controlling the surface characteristics of a lamination film, and thereby regulating gloss of the surface of a lamination film winded in a roll form, the inventors completed example embodiments.

One objective of the embodiment is to provide a lamination film with improved visibility during appearance inspection by regulating irregular surface gloss, which occurs on the wrinkled surface of the film, which is winded as a roll shape, and a light-transmitting laminate including the same.

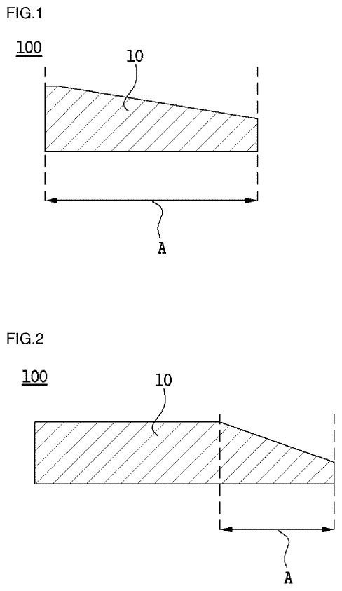

FIG. 1 and FIG. 2 are sectional views for schematically showing a lamination film according to one embodiment, respectively. Hereinafter, example embodiments will be described in further detail with reference to FIG. 1 and FIG. 2.

To achieve the above objective, the lamination film according to one embodiment disclosed in the present disclosure includes an increasing thickness area. The increasing thickness area has two ends, i.e., a first end and a second end. The thickness of the increasing thickness area increases from the first end to the second end. Also, the lamination film includes at least one surface including a plurality of embossments, and at least a portion of the at least one surface, where the plurality of embossments are formed, is disposed on the surface of the increasing thickness area. The maximum value among gloss values measured at an acceptance angle of 20°, 45°, 60°, 75° and 85° is 15% or less at the first portion and the second portion separated from the first portion on the at least one surface, respectively. Also, a Spd value of the at least one surface, where embossments are formed, is 200 mm⁻² or more.

The first portion and the second portion are some parts of the surface, where embossments are formed that are not overlapped from each other, and the detailed description thereof will be made below.

The increasing thickness area (A) has two ends, i.e., the first end and the second end, as viewed at the section, and the two ends are different in the thickness.

The thickness of the increasing thickness area (A) may increase as going from the first end toward the second end. The thickness may increase in a fixed ratio in the increasing thickness area (A) overall. The thickness may increase in a gradually increasing ratio in the increasing thickness area (A) overall. The thickness increase may be shown in a gradually decreasing ratio in the thickness area (A) overall.

Conversely, the thickness of the increasing thickness area (A) may decrease as going from the first end toward the second end. The thickness may decrease in a fixed ratio in the increasing thickness area (A) overall. The thickness may decrease in a gradually increasing ratio in the increasing thickness area (A) overall. The thickness may decrease in a gradually decreasing ratio in the thickness area (A) overall.

In the increasing thickness area (A), the thicknesses of two ends are different from each other and thereby the route of a transmitted light or the angle of a reflected light is regulated, not to form a double image when a light is irradiated toward a light-transmitting laminate from a light source of a Head Up Display system.

The increasing thickness area (A) has a wedge angle (θ), the wedge angle (θ) is expressed by below Equation 2, and the wedge angle in the increasing thickness area (A) may be 0.01° to 0.04°:

$$θ = arctan ( \frac{Hb - Ha}{w} ) \qquad [ Equation 2 ]$$

In the Equation 2, Hb is a thickness of a thicker side between two ends of the increasing thickness area (A). Ha is a thickness of a thinner side between two ends of the increasing thickness area (A). w is a width length connecting two ends of a increasing thickness area (A).

Hb and Ha values can be measured by using Mitsutoyo 547-401 thickness gauge, but not limited thereto.

A wedge angle in the increasing thickness area (A) may be 0.01° or more. A wedge angle in the increasing thickness area (A) may be 0.011° or more. A wedge angle in the increasing thickness area (A) may be 0.04° or less. A wedge angle in the increasing thickness area may be 0.03° or less. A lamination film having such a wedge angle can efficiently prevent the formation of a double image when used as an interlayer for Head Up Display.

The ratio of the Ha compared to w may be 0.0002 to 0.0015.

Specifically, the Ha value may be 0.38 mm or more. The Ha value may be 0.40 mm or more. In this case, a lamination film can have stable penetration resistance and can prevent the formation of a double image when applied to a Head Up Display system.

A ratio of Ha compared to w may be 0.0002 or more. A ratio of Ha compared to w may be 0.0003 or more. A ratio of Ha compared to w may be 0.0015 or less. A ratio of Ha tow may be 0.0013 or less. In such a case, a lamination film can project a distinct image on the surface of a light-transmitting laminate when included in a Head Up Display system while having excellent durability.

A ratio of Hb to w may be 0.001 or more. A ratio of Hb to w may be 0.0012 or more. A ratio of Hb to w may be 0.002 or less. A ratio of Hb compared to w may be 0.0018 or less. In such a case, it is possible to provide a lamination film, which can protect a driver from external impact and have functionality of preventing a double image.

The increasing thickness area (A) may be disposed in some or all of the lamination film 100.

When the increasing thickness area (A) is disposed in some of the lamination film 100, the increasing thickness area (A) may be disposed in the edge close to one side in a machine direction of the lamination film 100.

When the increasing thickness area (A) is disposed in some of the lamination film 100, the increasing thickness area (A) may be disposed between one side in a machine direction and the center of the lamination film 100.

When the increasing thickness area (A) is disposed in some of the lamination film 100, the increasing thickness area (A) may be disposed in the center between one side and the other side in a machine direction of the lamination film 100.

The lamination film 100 may include one, two or more increasing thickness areas (A).

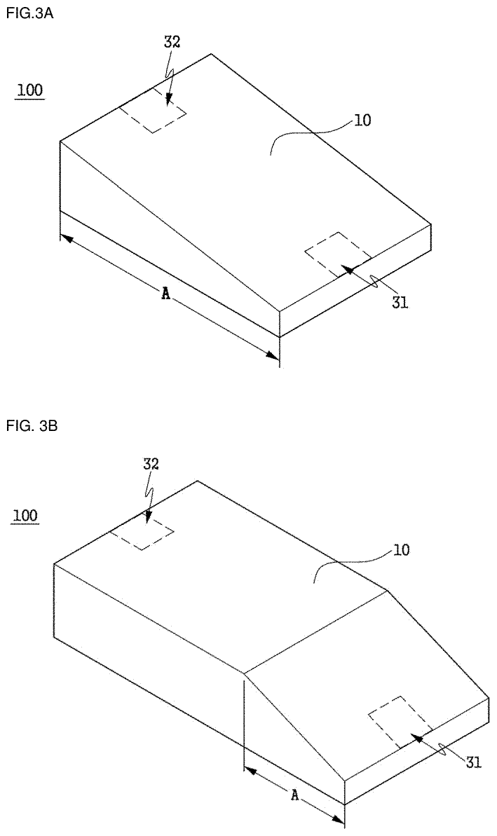

FIGS. 3A and 3B are sectional views for schematically showing a measuring portion for gloss of the lamination film according to example embodiments. Hereinafter, example embodiments will be described in further detail, with reference to FIGS. 3A and 3B.

The lamination film includes a surface, where embossments are formed. At least a part of the surface, where embossments are formed, is disposed on one surface of the increasing thickness area.

Gloss of the surface, where embossments are formed, is evaluated according to JIS Z 8741-1997. A measured value of gloss may be taken by using a gloss gauge. The measurement of gloss is made in the first portion 31 and the second portion 32 of the lamination film.

The first portion 31 and the second portion 32 are some parts of the surface, where embossments are formed, that are spaced apart from each other.

In detail, the first portion 31 is a square shaped portion having width*length of 10 cm*10 cm or more, when one thinner edge of the lamination film is designated as one side of the square, wherein the one thinner edge is selected from one side edge and the other side edge of the film that are disposed to be opposite from each other in a width direction in the surface, where embossments are formed of the lamination film. For example, a square shaped portion having width*length of about 30 cm*30 cm may be the first portion 31.

In detail, the second portion 32 is a square shaped portion having width*length of 10 cm*10 cm or more, when a thicker edge between one side edge and the other side edge that are located to be opposite from each other in a width direction in the surface where embossments are formed of the lamination film, is designated as one side of the square. For example, a square shaped portion having width*length of about 30 cm*30 cm may be the second portion 31.

The measurement for gloss of the respective first and second portions may be evaluated by an average value of gloss values measured from samples, respectively, after the samples are obtained by cutting the first portion 31 or the second portion 32 from the lamination film.

In detail, one surface of the first portion 31 or the second portion 32 is randomly divided into five portions. After an acceptance angle is set, gloss by each portion is measured one time. Thereafter, the other surface of the first portion 31 or the second portion 32 is randomly divided into five portions and gloss by each portion is measured one time in the same manner. Total ten measured values are taken from one surface and the other surface of corresponding first portion 31 or second portion 32, and the average value thereof is respectively considered as gloss of the first portion 31 or the second portion 32.

For example, gloss may be measured by using VG-7000 model available from NIPPON DENSHOKU according to JIS Z 8741-1997.

In respective first portion 31 and second portion 32 of the surface, where embossments are formed, the maximum value among gloss values measured at an acceptance angle of 20°, 45°, 60°, 75° and 85° may be 15% or less. The maximum value may be 12% or less. The maximum value may be 10% or less. The maximum value may be 3% or more. The maximum value may be 4% or more. The maximum value may be 5% or more. In such a case, the intensity of a reflected light which is reflected from illumination in various angles on the roll surface can be regulated.

In respective first portion 31 and second portion 32 of the surface, where embossments are formed, the standard deviation of gloss measured by acceptance angle can be regulated. In a process of inspecting a lamination film unwound from a roll form by naked eyes, a light reflected on the roll surface forms various acceptance angles while being reached to eyes of a worker. When the increasing thickness area is present in at least a part of a lamination film, the lamination film kept in a roll form generates a wrinkle due to a thickness difference between one end and the other end in a width direction, and the wrinkle will be maintained if not passing a separate stabilizing process. When the standard deviation of gloss by acceptance angle is not regulated, the intensity of a reflected light, which forms a certain acceptance angle among lights reflected on a wrinkled portion, may be excessively strong, and this may lead to degradation of visibility of the lamination film.

In respective first portion 31 and second portion 32 of the surface, where embossments are formed, the standard deviation of gloss values measured at an acceptance angle of 20°, 45°, 60°, 75° and 85° may be 6% or less. The standard deviation may be 5% or less. The standard deviation may be 1% or more. The standard deviation may be 2% or more. In such a case, decrease of workability due to a reflected light on the roll surface can be prevented when the appearance is inspected.

In the first portion 31 of the surface, where embossments are formed, the gap between the maximum and the minimum among gloss values measured by acceptance angle can be regulated. In a case of a lamination film having one end and the other end different in the thickness from each other, a wrinkled surface may be formed when the lamination film kept as a roll form is unwound. The wrinkle is relatively frequently formed in a portion whose thickness including the first portion 31 is relatively thin. And when a light is incident on the wrinkled surface, various acceptance angles are formed, and irregular surface gloss is formed on the wrinkled surface. This may cause optical fatigue to a worker inspecting the appearance of a lamination film. Among gloss values measured by acceptance angle in the first portion 31, the gap between the maximum and the minimum is regulated in addition to regulation of the maximum gloss value and thereby degradation of visibility due to irregular surface gloss can be prevented.

In the first portion 31 of the surface, where embossments are formed, the gap between the maximum and the minimum among gloss values measured at an acceptance angle of 20°, 45°, 60°, 75° and 85° may be 10% or less. The gap between the maximum and the minimum may be 8% or less. The gap between the maximum and the minimum may be 1% or more. The gap between the maximum and the minimum may be 3% or more. In such a case, irregular surface gloss occurring due to wrinkled surface of a roll is regulated and thereby degradation of visibility of a lamination film can be prevented.

In respective first portion and second portion of the surface, where embossments are formed, the sum of gloss values measured at an acceptance angle of 20°, 45°, 60°, 75° and 85° may be 50% or less. The sum of gloss values may be 40% or less. The sum of gloss values may be 35% or less. The sum of gloss values may be 10% or more. The sum of gloss values may be 15% or more. The sum of gloss values may be 20% or more. The average value of gloss values measured at an acceptance angle of 20°, 45°, 60°, 75° and 85° of the surface where embossments are formed may be 7% or less. The average value of gloss values may be 5% or less. The average value of gloss values may be 4% or less. The average value of gloss values may be 1% or more. The average value of gloss values may be 2% or more. In such a case, visibility of a lamination film can be improved when the appearance of the film is inspected.

A Spd value of the surface, where embossments are formed, is evaluated according to ISO_25178. A measured and calculated value of the Spd value can be taken by using a three-dimensional roughness meter.

The measurement of 3D roughness may be evaluated by the average value of values measured in a total area of 1,000,000 μm² or more. In detail, when measured by using a three-dimensional optical profiler or a 3D laser measuring microscope, the 3D roughness may be respectively measured five times or more at different positions, wherein each area respectively has a size of 340 thousand μm² or more, and the average of values except for the maximum and the minimum can be used as a measured value for three-dimensional roughness. When using a 3D laser measuring microscope, 3D roughness can be measured by utilizing STICHING function to join images in neighboring positions from one another, and the measurement of 3D roughness utilizing this STICHING function can also be evaluated by the average of values measured in a total area of 1,000,000 μm² or more.

For example, OLS 5000 model of 3D Optical Microscopy available from OLYMPUS may be used to measure and to obtain 3D roughness. The measured image is corrected by ordinary GAUSSIAN filter, small scale lateral components are removed with S-filter, and subsequently a Spd value is measured.

Ordinarily, when S-filter of 8 μm cut off is applied, scale lateral components with a width of less than 2 μm are removed, and when S-filter of 50 μm cut off is applied, scale lateral components with a width of less than 12 μm are removed.

As a method of regulating a Spd value of the surface, where embossments are formed, of the lamination film, for example, there are a method of regulating the shape and the size of an embossment pattern of an embossment mold or roller, a method of additional processing of a minute unevenness on the surface of an embossment mold or roller, and a method of applying a melt fracture process, but the method is not limited thereto.

A lamination film may regulate a Spd value of the surface, where embossments are formed, to regulate gloss by acceptance angle. Regulating a Spd value of the surface, where embossments are formed, means that the number of embossment peaks per unit area is regulated. When a Spd value of the surface, where embossments are formed, is regulated within a certain range, a light incident on the surface of the lamination film is reflected on the surface of plural embossment peaks and reflected in different angles. That is, it is possible to inhibit total reflection of a light occurring on the surface of the lamination film, and diffuse reflection may be caused. Thus, gloss of the lamination film can be regulated by regulating the shape of a surface profile of the surface, where embossments are formed, and regulating the degree of diffuse reflection of an incident light.

A Spd value of the surface, where embossments are formed, may be 200 mm⁻² or more. The Spd value may be 300 mm⁻² or more. The Spd value may be 400 mm⁻² or more. The Spd value may be 1500 mm⁻² or less. The Spd value may be 1200 mm⁻² or less. The Spd value may be 800 mm⁻² or less. In such a case, the lamination film is regulated to have improved gloss and visibility.

A Sku value of the surface, where embossments are formed, may be 0.5 to 4.

The Sku value is a value evaluated according to ISO_25178, and an index for evaluating kurtosis (quotient of the mean quartic value of the ordinate values and the fourth power of Sq) in a certain area. The Sku value may be evaluated by below Equation 3:

$${S}_{ku} = \frac{1}{{S}_{q}^{4}} [ \frac{1}{A} \int {\int }_{A} {z}^{4} ( x , y ) dxdy ] \qquad [ Equation 3 ]$$

In the Equation 3, A is an area of a measuring target, z(x, y) refers to a height (z) value in x and y coordinates within the area of the measuring target, and Sq refers to root mean square height of the surface.

A measured and calculated value of Sku value may be taken by using a three-dimensional roughness meter. The measurement of 3D roughness is the same as the method for measuring a Spd value described in the above.

As the Sku value is higher, a surface profile of the surface, where embossments are formed, has a sharp shape, and as the Sku value is lower, the surface profile has a dull shape.

When a Sku value of the surface, where embossments are formed, is regulated within a proper range, total reflection of a light incident on the surface of the lamination film due to the surface profile of the surface, where embossments are formed, is inhibited, thereby gloss of the lamination film can be regulated, and the lamination film can have stable edge sealing and de-airing performance when laminated with a light-transmitting material.

A Sku value of the surface, where embossments are formed, may be 0.5 or more. The Sku value may be 1 or more. The Sku value may be 1.5 or more. The Sku value may be 4 or less. The Sku value may be 3.8 or less. The Sku value may be 3.5 or less. In such a case, gloss of a lamination film is regulated, and workability can be improved, and the lamination film can have stable edge sealing and de-airing performance.

A S10z value of the surface, where embossments are formed, may be 30 to 90 μm.

The S10z value is evaluated according to ISO_25178. A measured and calculated value of the S10z value can be taken by using a three-dimensional roughness meter. The measurement of 3D roughness is the same as the method of measuring the Spd value described above.

A S10z value of the surface, where embossments are formed, may be 30 μm or more. The S10z value may be 40 μm or more. The S10z value may be 45 μm or more. The S10z value may be 90 μm or less. The S10z value may be 80 μm or less. The S10z value may be 75 μm or less. In such a case, embossments can effectively inhibit total transmittance of an incident light, and the lamination film can have excellent edge sealing and de-airing performance.

The lamination film may include minute unevenness on a surface, where embossments are formed.

The minute unevenness may be formed in a peak of an embossment pattern, or may be formed in a valley of the embossment pattern.

It is possible to allow the surface, where embossments are formed, to have characteristics described above by applying a method of additionally processing a minute unevenness on one surface of a lamination film, or additionally processing a minute unevenness on the surface of a mold or a roller for transcribing embossments in a process of forming embossments. When a minute unevenness is additionally processed on the surface of the lamination film, the surface profile of the surface, where embossments are formed, is regulated and the gloss of a lamination film can be regulated.

In detail, the minute unevenness may be additionally processed by additionally processing the minute unevenness on a mold or roller for transcribing embossments to the lamination film, and thereby transcribing the pattern to the surface of the lamination film by using a mold or roller. For example, minute sand blast treatment may be applied to the mold or roller to process the minute unevenness additionally, but a method of additionally processing a minute unevenness is not limited thereto.

The lamination film may be a monolayer film or a multilayer film.

When the lamination film is a monolayer film, the lamination film may be composed of a bonding layer.

Hereinafter, the composition of a lamination film and the like will be described.

A lamination film may include a polyvinyl acetal resin, or may include a polyvinyl acetal resin and a plasticizer.

Specifically, the lamination film may include a polyvinyl acetal resin in an amount of 60 wt % to 76 wt %. The lamination film may include a polyvinyl acetal resin in an amount of 70 wt % to 76 wt %. The lamination film may include a polyvinyl acetal resin in an amount of 71 wt % to 74 wt %. When including a polyvinyl acetal resin in such a range, the lamination film can achieve relatively high tensile strength and modulus.

The polyvinyl acetal resin may include an acetyl group in an amount of less than 2 wt %.

The polyvinyl acetal resin may include an acetyl group in an amount of 0.01 or more and less than 1.5 wt %.

The polyvinyl acetal resin may include a hydroxyl group in an amount of 15 wt % or more.

The polyvinyl acetal resin may include a hydroxyl group in an amount of 16 wt % or more.

The polyvinyl acetal resin may include a hydroxyl group in amount of 19 wt % or more. Also, the polyvinyl acetal resin may include a hydroxyl group in an amount of 30 wt % or less. When such polyvinyl acetal resin is applied to the lamination film, it is possible to obtain mechanical properties such as proper penetration resistance while being bonded excellently with a material such as glass.

The polyvinyl acetal resin may be a polyvinyl acetal resin obtained by acetalization of a polyvinyl alcohol having a polymerization degree of 1,600 to 3,000 with aldehyde. The polyvinyl acetal resin may be a polyvinyl acetal resin obtained by acetalization of a polyvinyl alcohol having a polymerization degree of 1,700 to 2,500 with aldehyde. When such a polyvinyl acetal is applied, mechanical properties like penetration resistance can be sufficiently improved.

The polyvinyl acetal resin may be synthesized from polyvinyl alcohol and aldehyde, and the aldehyde is not limited in the type. In detail, the aldehyde may be selected from the group consisting of n-butyl aldehyde, isobutyl aldehyde, n-valer aldehyde, 2-ethyl butyl aldehyde, n-hexyl aldehyde and blend resins thereof. When n-butyl aldehyde is applied as the aldehyde, the produced polyvinyl acetal resin may have a characteristic in refractive index the difference of which with refractive index of glass is small, and may have excellent adhesion with glass and the like.

The lamination film may include a plasticizer in an amount of 24 to 40 wt %. The lamination film may include a plasticizer in an amount of 24 to 30 wt %. The lamination film may include a plasticizer in an amount of 26 to 29 wt %. When the plasticizer is included in such a range, the laminated lamination film can achieve a proper adhesive strength and impact resistance.

In detail, the plasticizer may be selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibutoxyethoxyethyl adipate (DBEA), butyl carbitol adipate (DBEEA), dibutyl sebacate (DBS), bis 2-hexyl adipate (DHA) and combinations thereof. Specifically, any one selected from the group consisting of triethylene glycol di-2-ethyl butyrate, triethylene glycol di-2-ethylhexanoate, triethylene glycol di-n-heptanoate and combinations thereof may be comprised as the first plasticizer, and further specifically, triethylene glycol bis 2-ethylhexanoate (3G8) may be applied.

The lamination film may further include an additive as needed, and for example, the additive may be selected from the group consisting of an antioxidant, a heat stabilizer, a UV absorber, a UV stabilizer, an IR absorber, a glass adhesion regulator and combinations thereof.

As the antioxidant, a hindered amine-based antioxidant or a hindered phenol-based antioxidant may be used. Specifically, on the process of manufacturing polyvinyl butyral (PVB), which needs a processing temperature of 150° C. or higher, a hindered phenol-based antioxidant is further preferable. The hindered phenol-based antioxidant may be for example, IRGANOX 1076, 1010, or so on available from BASF SE.

As the heat stabilizer, a phosphite-based heat stabilizer may be used considering suitability with an antioxidant. For example, the heat stabilizer may be IRGAFOS 168 available from BASF SE.

As the UV absorber, Chemisorb 12, Chemisorb 79, Chemisorb 74 or Chemisorb 102 available from CHEMIPRO KASEI KAISHA, LTD may be used, or Tinuvin 328, Tinuvin 329 or Tinuvin 326 available from BASF SE may be used. As the UV stabilizer, Tinuvin available from BASF SE may be used. As the IR absorber, ITO, ATO or AZO may be used, and as the glass adhesion regulator, a metal salt such as magnesium (Mg), potassium (K), sodium (Na), epoxy-based modified silicon (Si) oil or a mixture thereof may be used, but the present disclosure is not limited thereto.

The lamination film may be a multilayer film. The lamination film may be a laminate with two or more layers, a laminate with three or more layers or a laminate with five or more layers. The multilayer film may include a bonding layer in direct contact with a light-transmitting laminate such as a glass plate and a core layer distinct from the bonding layer. The core layer may include functionality, and for example, may have functionality such as heat insulating functionality.

The multilayer film may have at least one layer including the bonding layer, which may include a polyvinyl acetal resin corresponding to a composition of the monolayer described above or include a polyvinyl acetal resin and a plasticizer. Descriptions of the polyvinyl acetal resin and the plasticizer are overlapped with the above description and thus the further description is omitted.

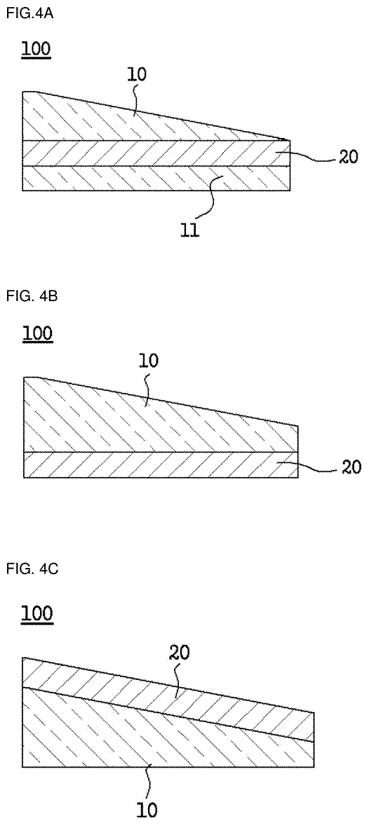

FIGS. 4A, 4B, and 4C are sectional views for schematically showing lamination films including a sound insulating layer according to different embodiments, respectively. Hereinafter, the example embodiments will be described in further detail with reference to FIGS. 4A, 4B, and 4C.

The lamination film may include an insulating layer 20. The sound insulating layer 20 may be placed between bonding layers 10 and 11, and may be placed on one surface of the bonding layer 10.

The sound insulating layer 20 may include a polyvinyl acetal resin.

The sound insulating layer 20 may include a polyvinyl acetal resin in an amount of 54 wt % or more. The sound insulating layer 20 may include a polyvinyl acetal resin in an amount of 60 wt % or more. The sound insulating layer 20 may include a polyvinyl acetal resin in an amount of 76 wt % or less. The sound insulating layer 20 may include a polyvinyl acetal resin in an amount of 70 wt % or less.

The sound insulating layer 20 may include plasticizer in an amount of 24 wt % or more. The sound insulating layer 20 may include a plasticizer in an amount of 30 wt % or more. The sound insulating layer 20 may include a plasticizer in an amount of 46 wt % or less. The sound insulating layer 20 may include a plasticizer in an amount of 40 wt % or less.

A polyvinyl acetal resin included in the sound insulating layer 20 may include an acetyl group in an amount of 8 mol % or more. The polyvinyl acetal resin may include an acetyl group in an amount of 8 mol % to 30 mol %. Also, a polyvinyl acetal resin included in the sound insulating layer may include a hydroxyl group in an amount of 26 mol % or less. The polyvinyl acetal resin may include a hydroxyl group in an amount of 10 wt % to 25 wt %. In such a case, it is possible to give a stabler sound insulating characteristic to the lamination film.

The lamination film 100 may be manufactured to be a sheet form by extruding a composition for manufacturing the lamination film including a resin and a plasticizer, and an additive as needed, and shaping it through a T-DIE or the like. When the lamination film is a multilayer film, a laminating mean such as a feed block may be further applied to the front of the T-DIE.

The lamination film 100 manufactured into a sheet form may be manufactured by passing processes such as control of a thickness and the formation of embossments to be the lamination film, but a manufacturing method of the lamination film in embodiments is not limited thereto.

When the lamination film 100 simultaneously has characteristics of the surface where embossments are formed and characteristics of the increasing thickness area (A), described above, the lamination film winded or unwound may have a double image preventing functionality in addition to a characteristic of regulated surface gloss.

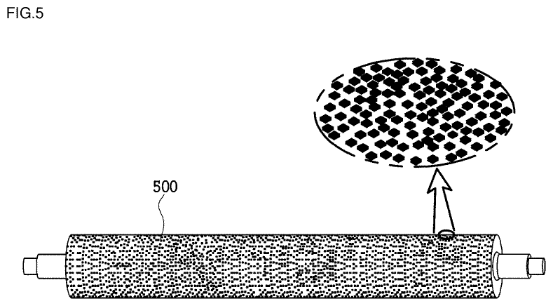

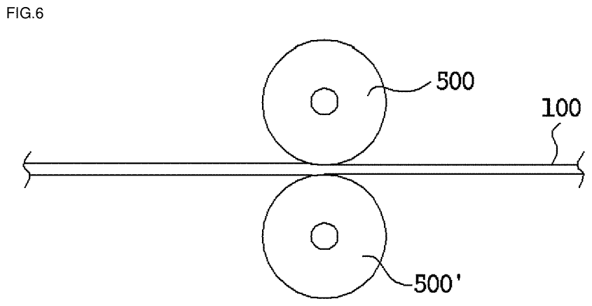

FIG. 5 is a conceptual view for illustrating an embossment roller applied in a manufacturing process of the lamination film of Comparative Example, and FIG. 6 is a conceptual view for illustrating a process of forming surface embossments in a manufacturing process of the lamination film manufactured in one example of the embodiments. Hereinafter, the manufacturing method of the lamination film having surface embossments of the present disclosure will be described with reference to FIG. 5 to FIG. 6.

A monolayer film or multilayer film 100 is manufactured into a sheet form by the same method as the above-described method, and thereafter an embossment roller 500 is applied to form surface embossments of the film, thereby manufacturing the lamination film.

The surface characteristics of the embossment roller 500 are transcribed to the surface of a monolayer film or multilayer film by applying a method of heating and pressurizing, which is ordinarily applied to a lamination film, and thus the characteristics of the surface, where film embossments are formed, can be controlled by controlling the surface characteristics of the embossment roller.

The embossment roller 500 may be manufactured by a method of grit blast treatment on the surface of a basic roller. At this time, the condition applied during the grit blast treatment (the size of particles, the pressure of injection, the distance of injection, the angle of injection and the like) may be adjusted to control the surface characteristics, and this influences the embossment characteristics of the film surface, complementarily.

For example, particles with an average diameter of 5 μm are injected to concaves of a basic roller, which has an Rz roughness value of 30 to 90 μm and unevenness in a matte pattern shape where dots are randomly formed, with a direct air blast system at a distance of 30 cm to 40 cm and an injecting pressure of 0.2 MPa, and at this time, the angle of a nozzle may be applied to be 75 to 105° thereby performing grit blast treatment one to ten times. Through the grit blast treatment, a minute unevenness can be formed on the surface of the film, complementarily, and thereby the gloss of the lamination film can be properly regulated.

The light-transmitting laminate according to another embodiment disclosed in the present disclosure includes a first light-transmitting layer, a lamination film disposed on one surface of the first light-transmitting layer, and a second light-transmitting layer disposed on the lamination film.

The first light-transmitting layer and the second light-transmitting layer may be a light-transmitting glass, or a light-transmitting plastic, respectively.

The lamination film is the lamination film described above, and the detailed description thereof is overlapped with the above description, and thus the further description is omitted.

The vehicle according to another embodiment disclosed in the present disclosure includes the light-transmitting laminate described above. The vehicle includes a body forming a main body of the vehicle, a driver (engine, etc.) attached to the body, a drive wheel attached to be rotatable to the body, a connector connecting the drive wheel and the driver; and a windshield attached to a part of the body, which is a light-transmitting laminate for blocking wind from outside.

Hereinafter, detailed embodiments will be described in further detail. However, the below examples are only just examples to aid understanding of the embodiments, and the scope of the present disclosure is not limited thereto. In below descriptions of experiments, when % is described without clear indication whether it is wt % or mol %, it refers to wt %.

Manufacturing Example: Processing of Roller

As indicated in FIG. 5, a roller having unevenness in a matte pattern shape (Rz=48 μm) was applied as ROLL 0. The roller surface was treated by grit blasting and thereby ROLL 1 and ROLL 2 were manufactured. The grit blast treatment was performed by injecting particles with an average diameter of 5 μm after passing an impurity removing filter with 200 mesh at a distance of 40 to 45 cm and an injecting pressure of 0.4 MPa with a direct air blast system. The angle of the roller surface and injected particles (or a nozzle) was 85 to 105 degrees.

ROLL 1 performed the above grit blast treatment two times, and ROLL 2 performed the above grit blast treatment three times.

The rollers manufactured in this manner were applied to Examples or Comparative Examples as indicated in below Table 1.

Manufacturing Example: Manufacture of Film

Manufacture of Resin Composition and Additive

Respective ingredients used in below Examples and Comparative Examples are the same as below.

Polyvinyl Butyral Resin (A): PVA and n-BAL having a polymerization degree of 1700 and a saponification degree of 99 were added to perform an ordinary synthesizing process, and thereby a polyvinyl butyral resin having a hydroxyl group of 20.3 wt %, a butyral group of 78.9 wt %, and an acetyl group of 0.8 wt % was obtained.

Manufacture of Additive: Irganox1076 as an antioxidant of 0.1 parts by weight, TINUVIN-328 as a UV absorber of 0.2 parts by weight, Mg Acetate as an adhesion regulator of 0.03 parts by weight were blended and mixed in a tumbler to be sufficiently dispersed (A total amount of 0.33 parts by weight).

Manufacture of Film

Example 1: The polyvinyl butyral resin (A) of 72.67 wt %, 3g8 as a plasticizer of 27 wt % and an additive of 0.33 wt % were added to one twin-screw extruder and manufactured into a sheet of a mirror surface, wherein the thickness of one end was 760 μm, the thickness of the other end was 1200 μm, and the width was 1.3 m. Thereafter, ROLL 1 was used before winded to perform embossing treatment and a film in which a surface pattern was transcribed was sampled in a form of a roll sample. The manufactured sheet had a thickness of 760 μm and a width of 1.0 M.

Example 2: While manufactured under the same condition as the manufacturing method of Example 1, Example 2 was manufactured by applying ROLL 2 as a pattern roller.

Comparative Example 1: While manufactured under the same condition as the manufacturing method of Example 1, the pattern roller was not applied before winding, a lip cooler was operated and thereby a melt fracture shape was formed on the surface of the extruded film. The temperature of the lip cooler was applied to be 130° C.

Comparative Example 2: While manufactured under the same condition as the manufacturing method of Example 1, Comparative Example 2 was manufactured by applying ROLL #0 as a pattern roller.

Evaluating Example: Evaluation of Properties

Measurement of 3D Roughness

3D roughness was measured through a measuring device, and Spd, Sku and Sz values were obtained respectively from the film surface according to ISO_25178. In detail, 3D roughness was measured by using a non-contact type three-dimensional roughness meter available from OLYMPUS (model OLS 5000), and the above values were obtained.

The 3D roughness values were measured by using an 1× ocular lens and 50× objective lens. At this time, the area with a breadth of 597.5 μm and a length of 523.5 μm could be scanned per one image. A measuring area was designated randomly from the same pattern, and four in a width direction and four in a length direction, as total sixteen images were repetitively measured. After that, stitching thereof was performed and thereby an image in a size with a breadth of 2390.2 μm and a length of 2381.2 μm was measured. The measured image was corrected under the condition of an ordinary GAUSSIAN filter and an S filter of 50 μm. The average of values except for the maximum and the minimum, which were measured from corrected data, was applied as a measured value of three-dimensional roughness, and the result was shown in below Table 1.

Measurement of Gloss

A sample with a size of 30 cm*30 cm was cut from the first portion and the second portion of the manufactured film of Examples and Comparative Examples. One surface of the sample was divided randomly into five portions. After setting an acceptance angle, the gloss by portion was measured one time. Thereafter, the other surface of the sample was randomly divided into five portions and the gloss by each portion was measured one time in the same manner. Total ten measured values were obtained, the average value thereof was calculated as gloss, and the gloss values were described in Table 2.

The acceptance angles were applied to be 20°, 45°, 60°, 75° and 85°. The gloss was measured by using VG-7000 model available from NIPPON DENSHOKU in accordance with JIS Z 8741-1997 as standard.

At respective first portion and second portion of Examples and Comparative Examples, the gloss depending on acceptance angles of 20°, 45°, 60°, 75° and 85° was measured, and subsequently, the gloss by acceptance angle, the maximum gloss, the standard deviation of gloss, the sum of gloss, the average gloss, and the difference value of the maximum gloss and the minimum gloss in the first portion of Examples and Comparative Examples were calculated to be described in Table 2 and Table 3.

Evaluation of Ease in Detecting Foreign Matter

Films in a roll sample shape of Examples and Comparative Examples were unwound, and total ten evaluators were allowed to be located around the unwound films. Thereafter, a light source was set under the same condition as an ordinary work for detecting foreign matter. Each evaluator evaluated whether the unwound film had excellent visibility enabling easy evaluation of detecting foreign matter by naked eyes. When seven or more people evaluated the film was excellent, it was enrolled as PASS, when less than seven people evaluated the film was excellent, it was enrolled as FAIL, and the result was shown in Table 1.

TABLE 1

| | | | | | Evaluation of |
|---|---|---|---|---|---|
| | | | | | Ease in |
| | | | | | Detecting |
| | | Spd | | S10z | Foreign |
| | Used Roller | (mm⁻²) | Sku | (μm) | Matter |
| Example 1 | ROLL #1 | 558 | 2.3 | 48.5 | PASS |
| Example 2 | ROLL #2 | 571 | 3.6 | 47.4 | PASS |
| Comparative | Not Applied | 187 | 0.6 | 49.9 | FAIL |
| Example 1 | | | | | |
| Comparative | ROLL #0 | 164 | 5.8 | 48.1 | FAIL |
| Example 2 | | | | | |

TABLE 2

| | Measured Result of Gloss (%) | | | | | |
|---|---|---|---|---|---|---|
| | | Acceptance | Acceptance | Acceptance | Acceptance | Acceptance |
| | | Angle of | Angle of | Angle of | Angle of | Angle of |
| | | 20° | 45° | 60° | 75° | 85° |
| Example 1 | The First | 0.3 | 2.8 | 4.2 | 5.1 | 1.3 |
| | Portion | | | | | |
| | The | 0.3 | 2.9 | 4.4 | 6.1 | 1.5 |
| | Second | | | | | |
| | Portion | | | | | |
| Example 2 | The First | 0.4 | 3.3 | 4.5 | 6.9 | 0.9 |
| | Portion | | | | | |
| | The | 0.5 | 3.6 | 4.9 | 7.9 | 1.2 |
| | Second | | | | | |
| | Portion | | | | | |
| Comparative | The First | 3.9 | 19.0 | 28.4 | 30.7 | 31.8 |
| Example 1 | Portion | | | | | |
| | The | 4.0 | 19.4 | 28.8 | 31.6 | 32.4 |
| | Second | | | | | |
| | Portion | | | | | |
| Comparative | The First | 5.1 | 9.1 | 26.5 | 22.1 | 18.9 |
| Example 2 | Portion | | | | | |
| | The | 5.6 | 10.1 | 28.6 | 23.5 | 21.6 |
| | Second | | | | | |
| | Portion | | | | | |

TABLE 3

| | Measured Result of Gloss (%) | | | | |
|---|---|---|---|---|---|
| | | | | | The |
| | | | | | Difference of |
| | | | | | the Maximum |
| | | | | | Value and the |
| | The | | The | The | Minimum |
| | maximum | Standard | Sum of | Average | Value in the |
| | Gloss | Deviation | Gloss | Gloss | First Portion |
| Example 1 | 6.1 | 2.03 | 28.9 | 2.89 | 5.8 |
| Example 2 | 7.9 | 2.68 | 34.1 | 3.41 | 7.5 |
| Comparative | 32.4 | 11.14 | 230.0 | 23.0 | 28.5 |
| Example 1 | | | | | |
| Comparative | 28.6 | 8.81 | 171.1 | 17.11 | 23.5 |
| Example 2 | | | | | |

In the Table 1 to Table 3, the cases of Examples 1 and 2 were measured to have a Spd value of 550 mm⁻² or more. In contrast, the cases of Comparative Examples 1 and 2 were measured to have a Spd value of 200 mm⁻² or less. This means when a minute unevenness is additionally processed on the surface of an embossment roller, the Spd value increases.

For Sku value, Examples 1 and 2 were measured to have a value of 0.7 to 4, and Comparative Examples 1 and 2 were measured to have a value of less than 0.7 or more than 4.

For S10z value, all the S10z values of Examples and Comparative Examples were measured to be within a range of 47 to 50 μm. This means, even though a minute pattern is additionally processed on the surface of an embossment roller, the S10z value does not have a great difference.

For the maximum gloss, Examples 1 and 2 were measured to have a value of less than 8%. In contrast, the Comparative Examples 1 and 2 were measured to have a value of 28% or more. This shows, when the embossment characteristics are regulated through additional processing of a minute pattern on the surface of a lamination film, the gloss by acceptance angle is decreased in the lamination film.

For the standard deviation by gloss, Examples 1 and 2 were measured to have a value of less than 3%. In contrast, Comparative Examples 1 and 2 were measured to have a value of 8% or more. This shows, when a lamination film regulated in the embossment characteristics, the variation of gloss depending on the change of acceptance value decreases.

For the sum of gloss, Examples 1 and 2 were measured to have a value of less than 35%. In contrast, Comparative Examples 1 and 2 were measured to have a value of 150% or more. Additionally, for the average gloss, Examples 1 and 2 were measured to have a value of 3.5% or less. In contrast, Comparative Examples 1 and 2 were measured to have a value of 15% or more. This shows a lamination film regulated in the embossment characteristics has gloss by acceptance angle in a wide range, which is decreased overall.

For the difference of the maximum value and the minimum value in the first portion, the cases of Examples 1 and 2 were measured to have a value of less than 8%. In contrast, the cases of Comparative Examples 1 and 2 were measured to have a value of 20% or more. This shows a film regulated in the embossment characteristics can inhibit degradation of visibility depending on irregular surface gloss occurring in the wrinkled surface of the wound roll.

For evaluation of ease in detecting foreign matter, the cases of Examples 1 and 2 were evaluated as PASS. In contrast, the Comparative Examples 1 and 2 were evaluated as FAIL. This shows, when the embossment characteristics of a lamination film is regulated, visibility increases when inspection of foreign matter is performed by naked eyes.

The lamination film, the light-transmitting laminate including the same, and the like of example embodiments control the characteristics of a surface, where embossments are formed, and thereby can improve visibility.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lamination film comprising an increasing thickness area,
wherein a thickness of the increasing thickness area increases from a first end to a second end,
wherein the lamination film comprises at least one surface comprising a plurality of embossments, and
wherein at least a portion of the at least one surface is disposed on a surface of the increasing thickness area.

2. The lamination film of claim 1,
wherein a maximum value among gloss values measured at an acceptance angle of 20°, 45°, 60°, 75° and 85° is 15% or less at a first portion and a second portion separated from the first portion on the at least one surface, respectively.

3. The lamination film of claim 1,
wherein a Spd value (number of peaks per unit area) of the at least one surface is 200 mm⁻² or more.

4. The lamination film of claim 1,
wherein when a thickness of the first end is referred to as Ha and a distance from the first end to the second end is referred to as w, a ratio of the Ha to the w is 0.0002 to 0.0015.

5. The lamination film of claim 1,
wherein a standard deviation of gloss values measured at an acceptance angle of 20°, 45°, 60°, 75° and 85° is 6% or less at a first portion and a second portion separated from the first portion on the at least one surface, respectively.

6. The lamination film of claim 2,
wherein a difference between the maximum value and a minimum value among gloss values measured at an acceptance angle of 20°, 45°, 60°, 75° and 85° is 10% or less at the first portion.

7. The lamination film of claim 1,
wherein the Spd value of the at least one surface is 1500 mm′ or less.

8. The lamination film of claim 1,
wherein a Sku value (kurtosis value) of the at least one surface is 0.5 to 4.

9. The lamination film of claim 1,
wherein a S10z value (ten point height of irregularities) of the at least one surface is 30 to 90 μm.

10. The lamination film of claim 1,
wherein the at least one surface comprises minute unevenness.

11. The lamination film of claim 1,
wherein the lamination film is a monolayer film with one layer or a multilayer film with two layers or more.

12. The lamination film of claim 1,
wherein the lamination film comprises a polyvinyl acetal resin.

13. A light-transmitting laminate comprising:
a first light-transmitting layer;
a lamination film disposed on one surface of the first light-transmitting layer; and
a second light-transmitting layer disposed on the lamination film;
wherein the lamination film comprises an increasing thickness area,
wherein a thickness of the increasing thickness area increases from a first end to a second end,
wherein the lamination film comprises at least one surface comprising a plurality of embossments, and
wherein at least a portion of the at least one surface is disposed on a surface of the increasing thickness area.

14. The light-transmitting laminate of claim 13,
wherein a maximum value among gloss values measured at an acceptance angle of 20°, 45°, 60°, 75° and 85° is 15% or less at a first portion and a second portion separated from the first portion on the at least one surface, respectively.

15. The light-transmitting laminate of claim 13,
wherein a Spd value (number of peaks per unit area) of the at least one surface is 200 mm⁻² or more.

16. The light-transmitting laminate of claim 13,
wherein when a thickness of the first end is referred to as Ha and a distance from the first end to the second end is referred to as w, a ratio of the Ha to the w is 0.0002 to 0.0015.

17. The light-transmitting laminate of claim 13,
wherein a standard deviation of gloss values measured at an acceptance angle of 20°, 45°, 60°, 75° and 85° is 6% or less at a first portion and a second portion separated from the first portion on the at least one surface, respectively.

18. The light-transmitting laminate of claim 14,
wherein a difference between the maximum value and a minimum value among gloss values measured at an acceptance angle of 20°, 45°, 60°, 75° and 85° is 10% or less at the first portion.

19. The light-transmitting laminate of claim 14,
wherein the Spd value of the at least one surface is 1500 mm⁻² or less.

20. The light-transmitting laminate of claim 14,
wherein a Sku value (kurtosis value) of the at least one surface is 0.5 to 4.
